(19) United States
(12) Patent Application Publication
(10) Pub. No.: US 2007/0088794 A1
(43) Pub. Date: Apr. 19, 2007

(54) Web-based method for information services

(75) Inventors: Robert P. Akins, Escondido, CA (US); Brian C. Klene, La Jolla, CA (US); Albert P. Cefalo, San Diego, CA (US); William C. Cray, Huntington Beach, CA (US)

Correspondence Address: William C. Cray;Cymer, Inc., Legal Dept., MS/4-2C, 17075 Thornmint Court, San Diego, CA, 92127-2413, US

(73) Assignee: Cymer, Inc., San Diego, CA (US)

(21) Appl. No.: 11/237,640

(22) Filed: Sep. 27, 2005

(51) Int. Cl. G06F 15/16

(52) U.S. Cl. 709/217

(57) ABSTRACT

A method of providing the service of obtaining information for a client is disclosed, which may comprise, providing a search service brokering internet location; providing an information search identification internet location accessible on or through the search service brokering internet location; providing an information search reference internet location associated with the information search identification internet location; and providing access to a searcher to the information search reference internet location to log in a reference. The search service brokering internet location may comprise a search service broker web-site; and the search identification internet location may comprise a search service broker web-site search web-page; and, the search reference internet location may comprise a search service broker web-site reference web-page. The method may also comprise date stamping the log in of a reference.

### FIELD OF THE INVENTION

The present invention relates to a method for soliciting information searches over the Internet.

### BACKGROUND OF THE INVENTION

There are many instances where an individual or entity seeks information. Along with other sources of information, the Internet has become an excellent tool for information searching and many databases and search engines have been created and utilized for such searching.

An example of such searching may be the investigation into the so-called prior art to claims in an issued patent or proposed claims in a patent application to be filed. By way of example data bases established, e.g., in the United States Patent and Trademark Office (“USPTO”) and in the World Intellectual Property Organization (“WIPO”) may be searched, e.g., utilizing key words, and various other databases, e.g., maintained by IEEE or SPIE or the like are available.

However, searches are most often best done by experts in the field who are usually more familiar with the sources of information and especially so when such sources may be in a graphical, schematic or pictorial or like form and/or in a language, any of which may be unfamiliar to the person or entity needing the information.

While searching is readily available to virtually anyone with a personal computer, or personal data assistant, blackberry, or the like, specialized skill and knowledgeable searchers are not. Wikipedia is an example of the availability of information for searching over Internet, which can be found at http://en.wikipedia.org/wiki/Main_Page. On the Wikipedia site persons logging in may search for information in an on-line free encyclopedia that is also apparently dynamically updatable by those who care to enter information into the Wikipedia encyclopedia. Google provides a service called “Answers” where a party can log on to the Google web-site and be linked to the “Answers” web-page and enter a question to be answered by someone from a panel of researchers apparently selected by Google, with the answer being provided for a fee. This can be seen at http://answers.google.com/answers.

Applicants in the present patent application propose an improved information searching method including a search and expert witness brokering business model for on-line use of information seekers to obtain information from searchers, also on line, and for searchers to opt to perform a search or be selected to perform a search. The business model also proposes techniques for charging search fees and providing financial compensation for successful searchers, e.g., in an automated fashion over the Internet.

### SUMMARY OF THE INVENTION

A method of providing the service of obtaining information for a client is disclosed, which may comprise: providing a search service broker internet location; providing an information search identification internet location accessible on or through the search service broker internet location; providing an information search reference internet location associated with the information search identification internet location; and providing access to a searcher to the information search identification internet location to identify the subject matter of a search and access to the information search reference internet location to report a reference, e.g., by logging in to the reference internet location to enter the identification of a reference. The search service brokering internet location may comprise a search service broker web-site. The search identification internet location may comprise a search service broker web-site search web-page. The search reference internet location may comprise a search service broker web-site reference web-page. The method may also comprise date stamping the log in of a reference. The method may further comprise logging in a client requesting a search, and logging in the identification of the search requested by the client and creating the search identification internet location for the respective search. The identification of the search may comprise a specific subject matter of the search for each respective search. The method may comprise logging in a searcher to do a search before providing the searcher with access to the search reference internet location to log in a reference. The method may comprise providing access to the information search identification internet location for the purpose of allowing a searcher to log in as a searcher for the search identified in the information search identification internet location. The method may further comprise charging a reference fee to the client for each entry of a qualified reference onto the search reference internet location wherein a qualified reference is a unique reference containing information that is the subject matter of the search and is logged into the search reference internet location earliest in time. The method may also comprise paying a portion of the reference fee to a searcher broker or individual searcher entering the qualified reference onto the search reference internet location. The method may further comprise determining the reference fee based upon the time since the information search was initiated. The method may also comprise logging in a selected individual searcher or searchers to do a particular search, which may be selected by the client, e.g., using information provided by the Search Service Broker. This could include limiting the “exclusive” nature of a search to a particular period of time.

### BRIEF DESCRIPTION OF THE DRAWINGS

FIG. 1 shows schematically and in block diagram form aspects of an embodiment of the present invention;

FIG. 2 shows schematically and in block diagram format aspects of an embodiment of the present invention;

FIG. 3 shows an exemplary of information contained in a database according to aspects of an embodiment of the present invention;

FIG. 3A shows an exemplary listing of the table entry definition for the table of FIG. 3;

FIG. 4 shows an exemplary of information contained in a database according to aspects of an embodiment of the present invention;

FIG. 4A shows an exemplary listing of the table entry definition for the table of FIG. 4;

FIG. 5 shows an exemplary of information contained in a database according to aspects of an embodiment of the present invention;

FIG. 5A shows an exemplary listing of the table entry definition for the table of FIG. 5.

### DETAILED DESCRIPTION OF PREFERRED EMBODIMENTS

The following is a glossary of terms used in the present application, which definitions define what the term comprises for purposes of this application and unless otherwise expressly indicated such term as used in the present application shall have the indicated meaning, whether bolded, in initial caps or otherwise highlighted or not:
Aging Factor—a modifier of fees charged to a Client and/or payments made to a Searcher for the identification of a Reference based upon the time passed, e.g., since the initiation of a Search or some point in time during the existence of a search where the applicability of an Aging Factor is made a part of the Search;
Client—an individual or entity requesting information, e.g., requesting a search for information, a search client, or requesting information about or identification of an expert, e.g., to act as an expert witness, an expert witness client, or other such requester of information;
Client Web-Page—an internet location assigned by the Search Service Broker to a Client for a search which may be set up so the Client can gain access to pertinent portion of the Search Service Broker Web-Site to initiate a search and to track the progress of a search, e.g., by getting access directly or through the Search service Broker Web-Site to the Search Reference List Web-Page for a given Search;
Critical Date—the date by which a Reference must have been available to the public, e.g., by publication, or a date specified by a Client, in order for the reference to qualify as a Qualified Reference;
Data Access Fee—a fee charged by the Search Service Broker for access to data in any database(s) created and maintained in the course of operation of the Search Service Brokering business, e.g., to find a Searcher Broker(s) and/or individual Searcher(s) to conduct a search regarding a particular Subject Matter or to locate a Searcher Broker(s) and/or individual Searcher(s) who may wish to offer the services of or act as an expert on a particular Subject Matter, e.g., as an expert witness in a court proceeding.
Dispute Process—a process for determining if a Reference is a Qualifying Reference and/or the appropriate Relevance Factor for a Reference;
Qualifed Reference—a Reference that is provided by a Searcher Broker and/or Searcher at the earliest time after the initiation of a Search and which discloses the Subject Matter of a Search or is sufficiently related to the Subject Matter of a Search, or satisfies the criteria of the Subject Matter of a Search as specified by a client, and in some cases may be required also to be effective as a reference on or before a designated Critical Date and/or meet other qualifying criteria;
Relevance Factor—a multiplier which may be attributed to a Reference regarding its level of pertinence to the Subject Matter of a Search, e.g., its degree of closeness of relationship to the Subject Matter of the Search and used, e.g., for determining a Search Fee charged to a Client, e.g., for a Reference and/or, e.g., a Reference Payment made to a Searcher Broker or individual Searcher for providing a Reference;
Reference—a document in electronic or tangible form containing information related to the Subject Matter of a Search;
Reference Identification Information—a listing of information that identifies a reference, e.g., by author(s), title, publication (including, e.g. volume, number and pages) and date of the publication, or, e.g., patent number and country for a patent reference;
Reference List—a list available at an Internet location accessible by Searchers to enter Reference Identification information for a Reference;
Reference Payment—an amount paid to a Searcher Broker and/or an individual Searcher, e.g., for providing a Qualified Reference, e.g., of a given Relevance Factor;
Search—a review of information containing sources to locate a Reference containing the Subject Matter of a Search or something closely related to the Subject Matter of a Search;
Search Service Broker—a party or entity operating an on-line business over the Internet, e.g., through a Web-Site, e.g., soliciting clients wishing to have an information Search conducted and Searcher Brokers and/or individual Searchers seeking to perform a Search;
Search Service Broker Web-Site—an Internet location accessible by clients seeking to obtain the service of having an information Search conducted and Searchers to enlist to perform a Search and/or enter results of performing a Search;
Searcher—an individual performing a Search for information and providing any discovered Reference directly or indirectly to the Search Service Broker;
Searcher Broker—an individual or entity, e.g., a University or University Department indirectly providing individual Searchers;
Searcher Broker Web-Site/Page—an Internet location accessible through or linked to the Search Service Broker Web-Site which may contain information relating to or links to information relating to individual searchers represented by the Searcher Broker;
Search Fee—an amount actually paid by a Client, e.g., to the Search Service Broker for a Search for, e.g., a Qualified Reference, e.g., of a given Relevance Factor, which may include, e.g., modifications due, e.g., to a Relevance Factor and/or an Aging Factor;
Subject Matter of a Search—a specifically defined piece of information that is the subject of a Search;
Standard Fee—a fee charged to a Client for the identification to the client of a Qualified Reference;
   Architecture

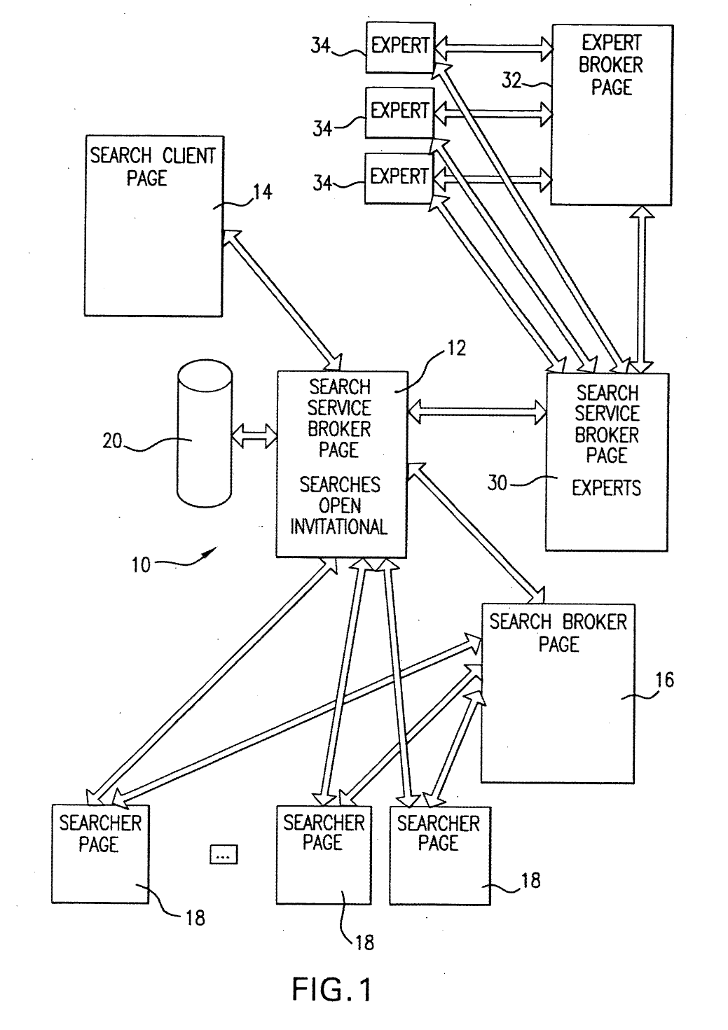

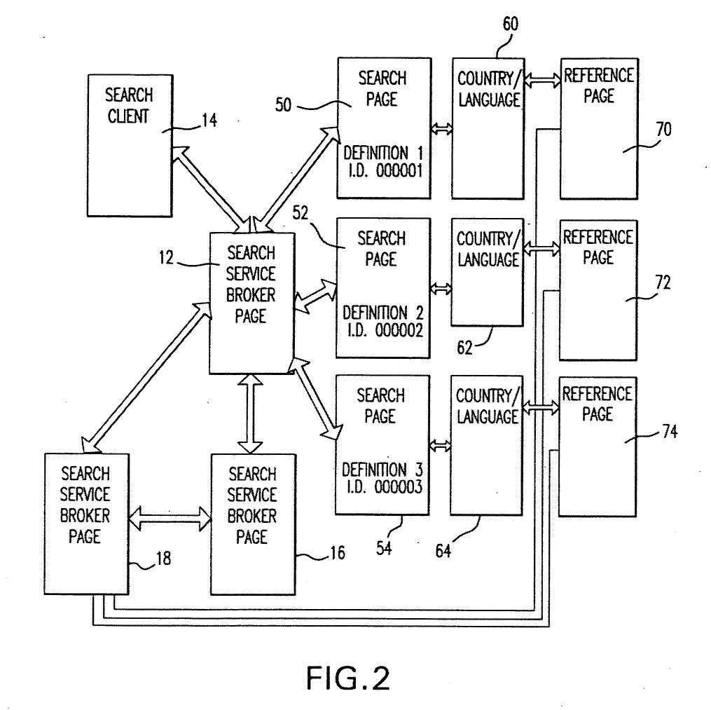

Turning now to FIGS. 1 and 2 there is shown an example of an Internet (Web-based) system architecture 10 for soliciting the conduct of an information search for a requesting client and soliciting/designating searchers to perform the search as well as to obtain payment of a fee from the client for effective results of the search, making payment for providing an effective result of the search to a searcher, and providing for brokers to collect search fees.

The system and method illustrated schematically in block diagram form in FIGS. 1 and 2 may comprise, according to aspects of an embodiment of the present invention, a search service broker Internet location such as a web-site 12. The Internet location 12 may have on it a search client web-page 14, which could also be the search client's own web-site simply linked to the search service broker web-site 12. The system may also include a searcher broker web-page 16, which also could be a separate linked web-site, for a person or entity that offers the services of a number of individual searchers. Each individual searcher may also have or be assigned an individual searcher web-page 18, which also could be a separate and linked web-site for the individual searcher linked directly to the search service broker web-site 12 and/or linked to or be a part of the searcher broker web-site and access the search service broker web site through the searcher broker web-site or web-page 16 or the like ways of providing a searcher with a web-page, e.g., having a unique internet access code, e.g., a URL. The client web-pages, searcher broker web-pages and the individual searcher web-pages may be part of the search service broker web-site and assigned to respective search clients,. searcher brokers and individual searchers, may be in existence or newly established by a searcher/searcher/broker, and linked to the search service broker web-site, or otherwise accessible and/or searchable, indexed or the like.

Linked to or a part of the search service broker web-site could be an expert service broker web-site/page 30 which may be linked to and/or have web-pages for an expert service broker web-site/page 30 and/or individuals offering their services as experts. The operation of the expert service broker web-site/page is similar to that of the search service broker web-site discussed in more detail herein, except for the service offered being the facilitation of the solicitation of the finding of an appropriate expert, e.g., to testify as an expert witness on a particular technological or other matter in a court proceeding. The same individuals or at least some of the same individuals that are solicited to conduct information searches as discussed in more detail below, e.g., searchers, may also be ones who might qualify as an expert witness. Therefore information gathered and maintained according to the operation of the information search service broker business and similar Internet linking software and databases and searching software may also be used in the expert broker business.

Therefore, in conjunction with operating the search service brokering business, the search service broker may also make available data gathered and stored in the course of the search service brokering business, e.g., particular searchers who have successfully found information relating to a particular subject matter of a search, where, e.g., the same or similar subject matter may be the subject of technical or other specialized expert testimony needed, e.g., for a court proceeding. This access to the search service broker's database may be provided for a fee, e.g., a data access fee. This may enable, e.g., a client desiring to find an individual qualified to act as an expert on a particular technological or other specialized information subject to search for, e.g., a searcher broker(s) and/or individual searcher(s) who have successfully provided information (e.g., references) relating to a particular subject matter of a particular search, where, e.g., the same subject matter is the subject of the expert information/testimony needed by the expert witness client who is seeking, e.g., the identification of a suitable expert this may also enable brokers of expert witnesses, e.g., who can act in a court proceedings to give expert testimony to obtain more exposure through the use of the expert witness Internet location of search service broker in a fashion like that of the searcher broker. Also this could enable brokers of expert witness services to expand the reach of their present offering of individuals to serve as expert witness, by, e.g., both being exposed to more clients for expert witnesses, through the expert witness service broker web-site and also by finding additional individuals that are possibly expert in a particular subject matter as evidenced by performing searches in a particular subject matter. Also it could enable individual searchers to also offer their services as an expert witness through the search service broker expert witness service portion of the search service broker's web-site for clients in need of such an expert, in a fashion similar to, e.g., logging in to perform open searches made available on the search service broker's web-site.

Shown schematically and in block diagram form in FIG. 2 is an exemplary architecture for soliciting searches and for having searches completed according to aspects of an embodiment of the present invention. The architecture may include, e.g., the search service broker web-page 12 interconnected to a search client web-page 14 and to individual searchers, e.g., directly through an individual searcher web-page 18 or indirectly through a searcher broker web-page or web-site 16. As can be seen by way of example in FIG. 2, each individual search, defined by a search definition as explained in more detail below, may be assigned, e.g., a search web-page 50, 52, 54, e.g., with an individual and unique search ID number, e.g., 00001, 00002 and 00003. Each search web-page 50, 52, 54 may have associated with it one or more identifying boxes separate web-pages, e.g., identifying the language/country to be searched in finding references associated with the subject matter of the search, e.g., boxes/pages 60, 62, 64. The search pages 50, 52 and 54, for example, may be linked directly or through, e.g., language/country boxes/pages 60, 62, 64 to a respective reference web-page 70, 72, 72 upon which searchers may enter reference identification information, e.g., for prospectively qualifying references as explained in more detail elsewhere. Searchers/searcher brokers may be able to directly link to a reference page 70, 72, 74 once such a reference page has been assigned by the search service broker, e.g., linked to a given search, and also once the searcher also has been, logged in, as a searcher for the search identified by the search web-page, or be required to log onto the reference page, e.g., through the search service broker web-site 12. In certain types of searches, e.g., confidential searches only a selected searcher(s)/searcher broker(s) may be allowed to access the respective reference page and inter references onto the reference page.

Search Server Broker Web-Site

According to aspects of an embodiment of the present invention a search service brokering internet location may be established by a search service broker. The search service broker Internet location may be, e.g., a search service broker Web-Site, which may be managed and controlled by the search service broker, e.g., to run a business of brokering information searches to clients wishing, e.g., to obtain the services of an individual or individuals, e.g., searchers, to perform an information search, as is more fully explained below.

Client Web-Page

When a client, an individual or entity, wishes to obtain the services of an individual searcher or individual searchers performing an information search the client may log on to the information search service brokering Internet location, e.g., the search service broker web-site, and may, e.g., be assigned, if not already so assigned, a client web-page which may be linked to and accessible through the search service broker web-site.

Client ID

Upon being logged in to the search service broker web-site the client may have a client web-page created. It will be understood that the client web-page may be created automatically as part of the log-in process when the client/prospective client seeks to access the search service broker web-page or may be created some time later in the process, e.g., after certain information about the client and/or commitments from the client have been obtained. In any event once a client web-page has been created it may contain, e.g., certain identifying information about the client, e.g., contact information, including, e.g., name, address, telephone number, email, etc. As noted below, this information identifying a client may or may not be made available to searchers or searcher brokers.

Search ID

For each search associated with the client a search identification will be provided and, e.g., a search web-page established for each given search, as explained more fully below. The search identification information may include, e.g., the type of search to be conducted by the search service broker for the client, e.g., an open search in which anyone with access to the search service broker web-site may access any open search and be able to enter a reference as explained in more detail below, or a confidential search in which the client or the search service broker (perhaps for an additional fee) selects a searcher or searchers to conduct the search for the client and others cannot access the particular search web-page or enter references to the reference list. The search may be a anonymous one, whether open or confidential, only in the former of which will the client be identified, e.g., on the search web-page or otherwise to any participating searcher.

The search identification information may also include the specific subject matter of the search as defined by the client, the search service broker and/or the two in combination.

Thus, a client wishing to have a search conducted but not to let anyone wishing to be a searcher, or masquerading as a searcher, know the search is being conducted may choose the confidential search. Should the client not care that anyone, e.g., with access to the search service broker web-site knows that a given information search is being conducted, but does not wish to be associated with the search may choose the anonymous search. The search service broker may charge an additional fee simply for keeping the search as a confidential search and, e.g., limiting potential participation in the search, which could potentially lessen the chances of a given qualified reference being found, and the search service broker obtaining its commission thereby. This could be in addition to any fee the search service broker may charge in a confidential search, e.g., for designating of helping to designate the searcher broker/individual searchers involved.

The search identification information may also include the listing of a critical date, e.g., in the example of a patent claim prior art search, the date on or before which a qualified reference must have bee available to the public, e.g., through publication.

Searcher Broker Web-Page

The method may provide for individual searchers to be represented by a searcher broker. The searcher broker could be, e.g., a university or a university professor, e.g., offering the services of a group of students and/or other professors as individual searchers and, e.g., be treated as a single searcher so far as interaction with the search service broker web-page and search pages, etc. The searcher broker could also allow the individual searchers it represents to log in as individual searchers, with, e.g., some identification to the search service broker that the reference payment is to go to the searcher broker or with some arrangement between the searcher broker and any individual searchers that any payment received by an individual searcher represented by a searcher broker will be subject, e.g., to some commission owed by the individual searcher to the respective searcher broker. The searcher broker may also have separate arrangements relating to payments, commissions, shared payments among all represented individual searchers, and the like that are outside the scope of the present invention.

Search Broker ID

The search broker can be given a search broker ID, e.g., associated with the search broker web-page linked to the search service broker web-site. The searcher broker may list on its web-page, accessible, e.g., from the search service broker web-page, e.g., the searchers and their experience and credentials, and their individual searcher IDs.

Searcher IDs

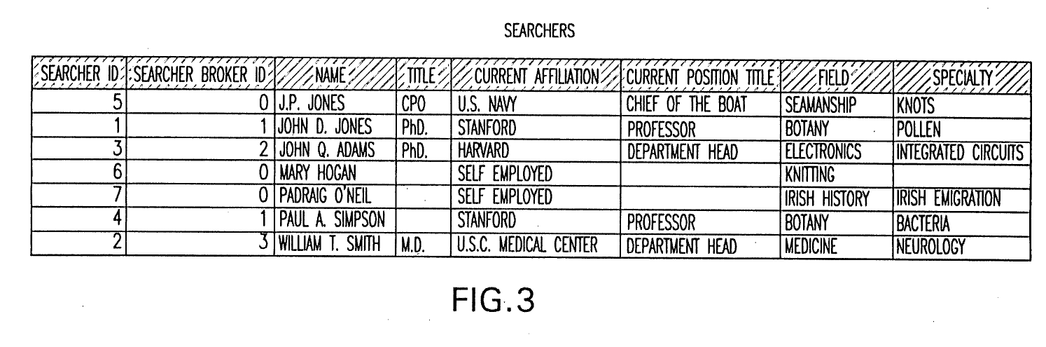

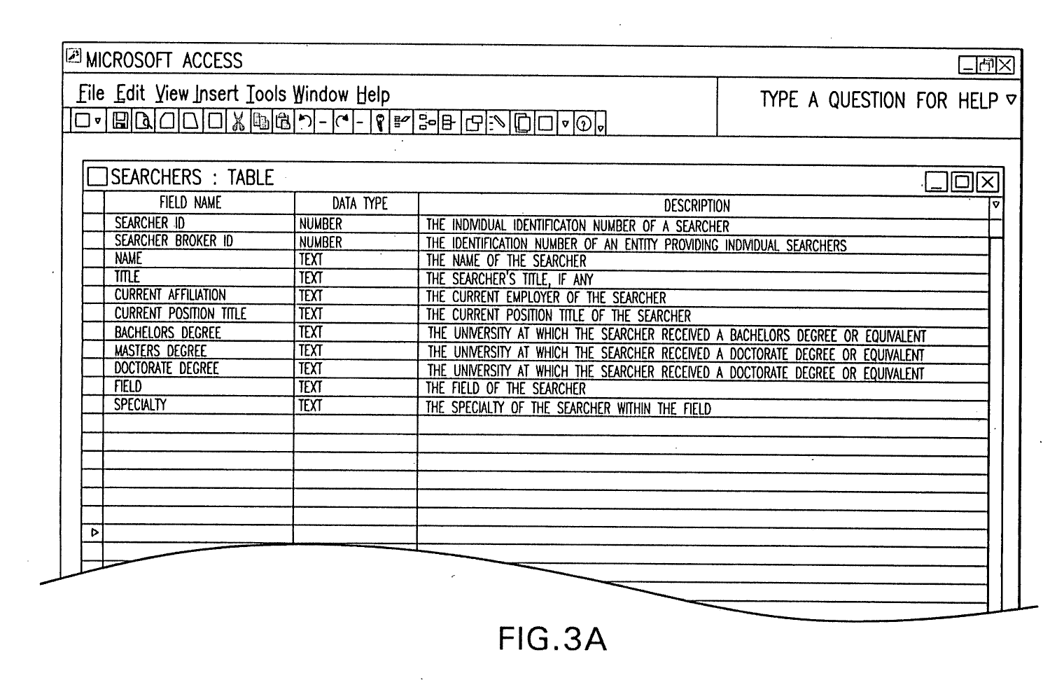

Each individual searcher may be given a unique searcher ID, e.g., a number. These may be stored in a database, e.g., in the form of a Microsoft Access relational database, e.g., as shown in an exemplary abbreviated form of a “Searcher” table 80 from such a database in FIG. 3. FIG. 3A shows the identification of the exemplary fields in the table 80 of FIG. 3. As indicated in FIG. 3 the database may contain in a row 82 of the table 80 the identity of the searcher by unique ID number and name, current affiliation and position, degrees possessed and, e.g., other possible identifying and experience-indicating information. The database may be accessed, e.g., from the search service broker web-site or the searcher broker web-page. The actual identification information for a searcher broker or an individual searcher may not be made available to clients or prospective clients. For example the searcher ID number and expertise of a searcher may be all that the search service broker allows aces to by clients or prospective clients.

It may also be desirable to allow a prospective searcher or searcher broker to have access to the search service broker's web-site and/or data base, before being logged in as a searcher and given a searcher ID. For example a prospective searcher or searcher broker may wish to become familiar with available searches before taking the trouble to log in as a searcher to see if any searches are pending in the searcher's searcher broker's field(s) of expertise. The searcher may, however, be required to log on as a searcher and be given a searcher ID before being able to log in a reference on the respective reference page and be paid for providing a qualified reference.

Searcher Page

Each individual searcher may have his or her own searcher web-page which may be linked to or otherwise accessed through the search service broker web-site and/or the searcher broker web-page, e.g., by the use of the searcher's name or, if known, ID number.

Search Page

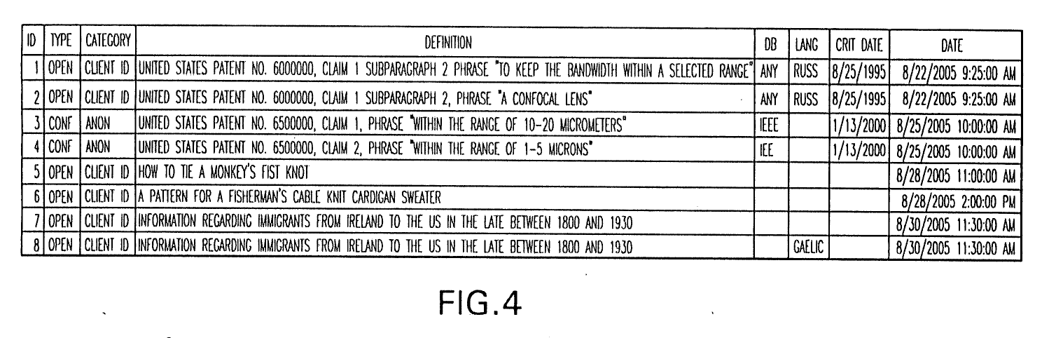

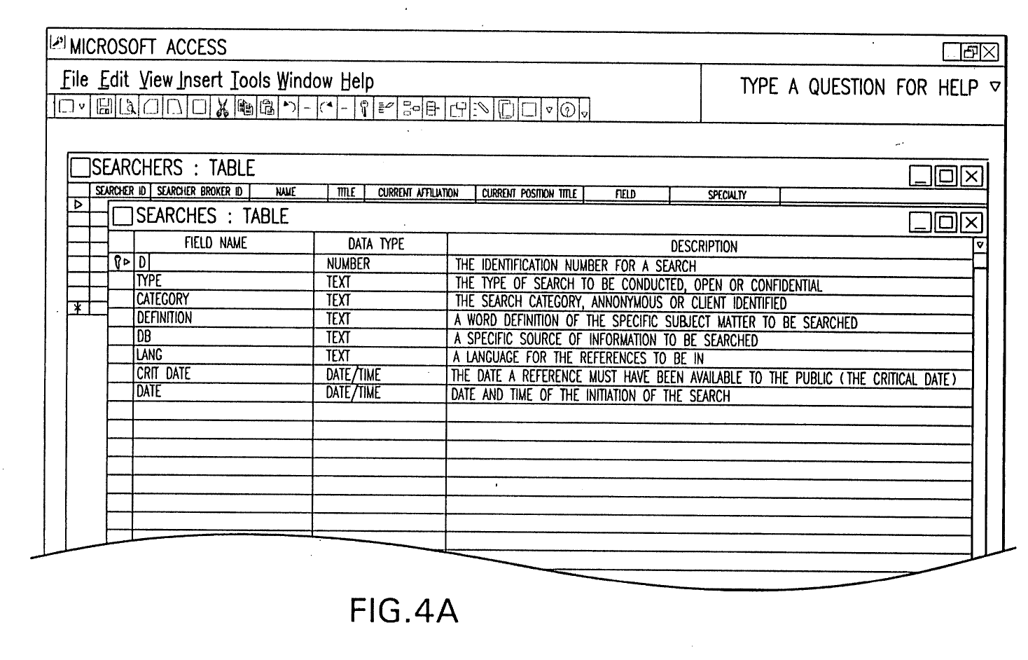

Each individual search may be given a unique search ID, e.g., a number, which may be stored in a database, e.g., as illustrated by example and in abbreviated form in the exemplary “Search” table 90 of FIG. 4. FIG. 4A shows an exemplary listing of the definitions of the fields in the table of FIG. 4. As can be seen in FIG. 4 an individual search identified in a given row 92, may contain the identity of a unique search, e.g., as accessed from the information contained in a database, e.g., . The table may also be assigned its own search web-page, e.g., accessible through a link from the search service broker web-page.

Search Identity

The search may be identified by an identifier, e.g., a number, and that number may be uniquely associated with a search web-page. The database may contain information relating to the search which may be accessible through or displayed on the search web-page. Along with the search ID may be included other information abut the search, e.g., whether it is an open or confidential search and whether it is anonymous or not, as explained more fully below. The information may also include any specific areas (particular databases, patent office records, etc.) in which the search is to be conducted and any specific country or language in which the search is to be conducted, also as more fully described elsewhere. The search identification may also include a date stamp for the time and date of the initiation of, e.g., the search web-page and/or database entry.

Subject Matter

The information identifying the search may include a specific definition of the subject matter of the search. By way of example, as illustratively shown in FIG. 4, in the case of searches for information in the form of prior art references to a patent or prospective patent claim, the subject matter may be identified by a specific claim in a specific patent, e.g., U.S. Pat. No. 6,000,000. This is shown by the listing of such patent number in the “Definition” field 100 of the illustrative table 90 shown in FIG. 4, e.g., in rows 110 and 112 of the table 100, as opposed to a search for information regarding another patent, e.g., prior art relating to a (fictitious) U.S. Pat. No. 6,500,000 identified in the “Definition” column in FIG. 4, e.g., in rows 120 and 122. The search may further be narrowed down to a specific portion of the selected claim, e.g., a sub-paragraph, or more narrowly a phrase, or even a specific word, also as illustratively shown in the “Definition” column of FIG. 4. As noted above, FIG. 4A is an example of how the data entry fields in the illustrative table 102 of FIG. 4 may be defined.

For example, again using the exemplary search for prior art to a specific claim in a specific United States Patent, the client requesting the search may know of prior art that shows everything in the identified claim except for, e.g., a particular feature of the claim. The feature being sought as the subject matter of the search may be identified by the phrase in claim 1 subparagraph 2—“to keep the bandwidth within a selected range” (by way of example only and not from a claim in the actual U.S. Pat. No. 6,000,000).

The searcher can then identify from the search definition that a direct hit on the subject matter of the search is believed to have been found, e.g., in the exemplary patent claim prior art reference type of information search, an anticipatory reference. Such a reference would, e.g., disclose all of the other elements or features of the identified patent claim, where specifically a feature identified in the noted subparagraph (such as by way of example “a fast tuning mechanism”) has as its purpose “to keep the bandwidth within a selected range.” As noted in more detail below, if found, such a prior art reference may constitute a reference of the highest in relevance designations, e.g., a high relevance reference, e.g., a “Level One” as noted elsewhere.

In some cases, the search may not be directed to Subject Matter that references a patent claim or specific language therein. For example, a search may be for other forms of information not related to patent claim prior art searching. In addition, however, even where the search is of the exemplary patent claim prior art search, the Subject Matter of the search may be, e.g., a short narrative. The short narrative may be provided by the client, e.g., in an effort to disguise a patent claim prior art search as relating to a specific patent, allowing an open search to be the type conducted. The client may have other reasons for using such a short narrative rather than specific claim language. In some cases, the client may seek assistance from the search service broker in preparing an appropriate short narrative, which the search service broker may do as part of its service, or for an additional fee.

Reference Page

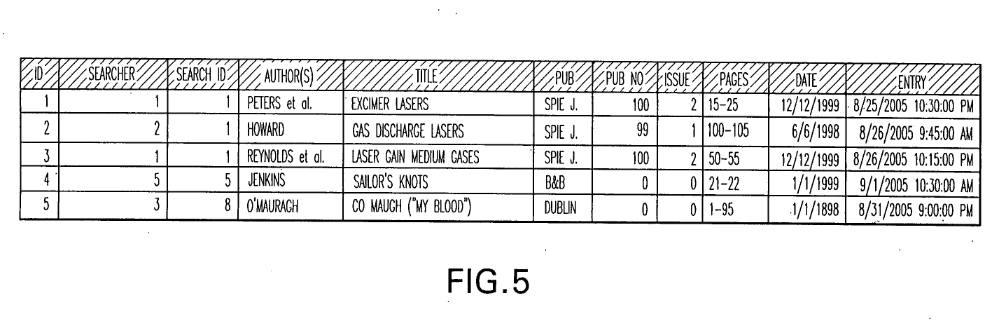

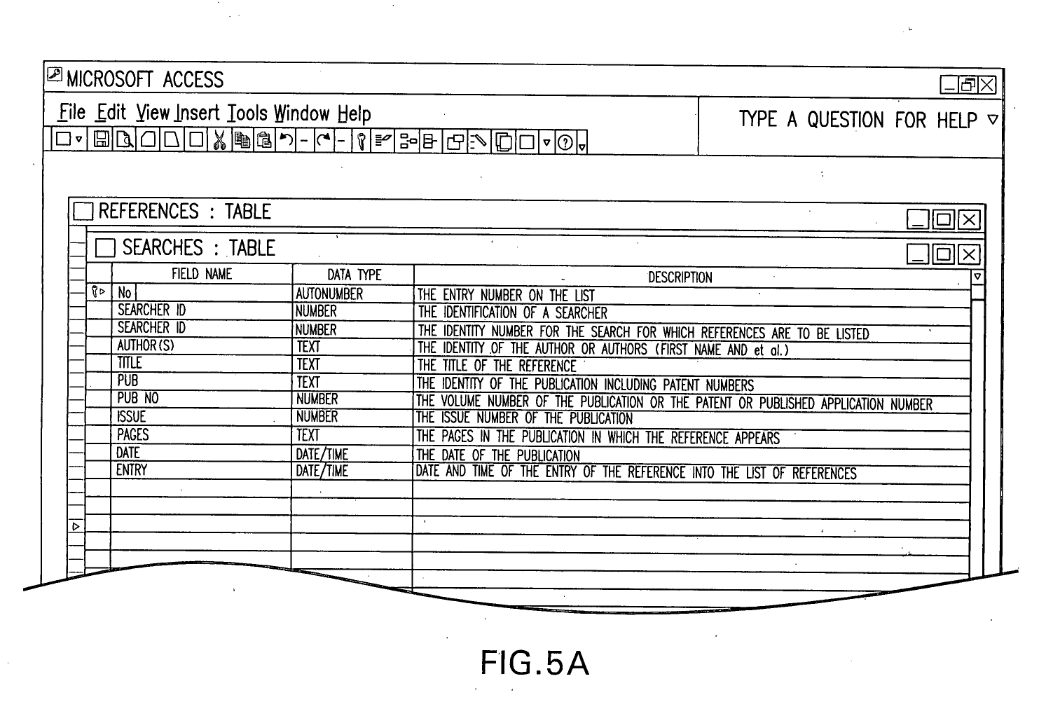

The search service broker may establish a web-page related to a specific unique search and, either on the search web-page or linked through the search service broker web-page or the search web-page can be found the search web-page, e.g., by anyone wishing to enter a reference in, e.g., an open search and designated/selected searchers in, e.g., a confidential search. As shown in FIG. 5, a data entry table 130, e.g., contained on or accessed through the reference web-page may require the entry of certain information about the information being sought under the search. This information may include, e.g., information entered into a specific row 132 for a given search, e.g., identifying a prior art reference in the example of the patent claim prior art search, e.g., the title, author(s), publication (including, e.g., volume and number, pages and publication date, as is shown by the example of the definitions of the respective fields in FIG. 5 shown in FIG. 5A. The table entries can also identify other references besides patent claim prior art references for searches not related to patent claim prior art, e.g., as shown in the specific entries in rows 134 and 136 of table 130 illustrated in FIG. 5.

When entered into the reference list, which may be stored in a database, e.g., automatically updated upon entry of the information in the reference web-page, or otherwise update by or through the search service broker, the reference can be given a date stamp and be identified as a reference submitted by a searcher broker and/or individual searcher having a search broker or individual searcher ID. If later it is determined, e.g., due to error in entering the reference identification information or otherwise, that two entries of the same reference occur on the reference list, then the one with the earliest date stamp will be the sole qualifying reference. In addition, the date stamp may be utilized in determining the fee charged to the client for the search and the payment to the search broker or individual searcher, e.g., in an aging fee search.

Relevance Level

A reference relevance level may be assigned to a given reference entered into the reference list. This may be assigned initially by the search broker and/or individual searcher. Relevance levels may include, e.g., in the example of the patent claim prior art reference search:

Level One—the subject matter of the search in the same use exactly;

Level Two—the subject matter of the search in the same field but for a different though related use; or

Level Three—the subject matter of the search in the same use, but in a different field.

There may be other levels of relevance and they, along with the terms such as “same field,” may be the subject of further definition and agreement by and among the parties, i.e., the client, search service broker and searcher broker and/or individual searchers, but the concept is that these levels of relevance may then be used to determine the fee charged to the client for a given reference of a given relevance level. For Example, in the exemplary patent claim prior art search, Level One may correspond to what is known in the patent law as an “anticipatory” prior art reference. Level Two and Level Three, or additional such levels, as appropriate, may relate to various degrees of pertinence for what are known in the patent law as “obviousness” references. The fee schedule may multiply the fee for a given reference, e.g., by a multiplier depending on the Level, with, e.g., a small multiplier for increasing Level numbers, i.e., Level One, Level Two, Level Three, etc. In this manner the most relevant reference, e.g., an “anticipating” reference can be valued the most for purposes of finding fee and consequent searcher payment and lower levels of pertinence to “obviousness” can be valued progressively less.

Open Searches

Where the client for the Search is not concerned that any other person or entity is aware that such a search is being conducted then the search may be constructed as an open search. This may be, e.g., in the example of the patent claim prior art search where the client for the Search is not concerned that, e.g., the owner of the patent may become aware that someone is seeking to find such information, e.g., prior art references relating to a claim or claims in such patent. An example of an open search situation may include, e.g., a client writing a book on immigration to the United States, e.g., by the Irish in the later 1800's and early 1900's and may wish to have certain libraries or other archives in Ireland searched and maybe also include both references and other writings, e.g., personal letters in both English and Gaelic searched. Thus the search identification, e.g., as shown in rows 114, 116 of FIG. 4 an open search may be solicited to be conducted in physical records in Ireland in English or Gaelic as to accounts of immigrants or those left behind by immigrants to the United States.

An open search may be distinguished from another form of search, e.g., a confidential search, e.g., by the fact that anyone with access to the internet may, e.g., by entering the search service broker web-page and being given access to or the ability to search through all existing open searches, may seek to be identified as an individual searcher performing a given search. An open search may or may not be open in other ways, e.g., searcher brokers and individual searchers may or may not be able to identify other searcher brokers and/or individual searchers competing for the finding of qualified references for a given search, whether designated an open search or not.

Regardless of whether or not a search is conducted as an open search, the search service broker and/or the searcher broker may wish to keep the identity of any individual searcher confidential, e.g., as a business trade secret. In such event, e.g., search brokers and/or individual searchers may be logged into the search service broker web-site and assigned an ID and perhaps also a web-page, but access to the identifying information about the searcher broker and/or individual searcher may not be made available to search clients, other searcher brokers and/or other individual searchers. Where, e.g., a particular search broker or individual searcher wishes to advertise an ability to act as an searcher and/or other information, e.g., the successful completion of prior searches, e.g., in a particular subject matter(s), then this may be done on or through the search service broker web-site. Whatever arrangements need to be made between the search service broker and such searcher broker and/or individual searcher, e.g., to provide for an exclusive arrangement for the searcher broker/individual searcher for the search service broker, if that is what the search service broker is trying to protect through maintaining searcher identity confidential, can be dealt with by the parties, perhaps as part of the initial logging in of a searcher broker/individual searcher and the concomitant contractual agreements, of outside the arrangement for being available to carry out and carrying searches through the search broker web-site.

Searcher brokers and/or individual searchers may wish to have their identity kept in confidence, e.g., an individual with another job that is acting as a searcher on the side. This can similarly be arranges as the case where the searcher broker and/or search service broker desires the confidentiality of searcher identifying information, beyond, that is some searcher ID number or other identity code.

Confidential Searches

Where the client for a search is concerned that the fact that a given information search is being conducted is known to the public, e.g., in the patent claim prior art search example, that the owner of the particular patent not know that a person or entity is searching for prior art relating to the patent, then the search may be conducted as a confidential search. In the event that a search is a confidential search, then the ability of prospective search brokers and/or searchers with access to the Internet, i.e., to the search service broker Internet location, e.g., web-site and concomitant access to information regarding available searches in which to partake, can be limited so that the existence of a confidential search can thus be made not accessible. In this event also, either or both of the client for the confidential search and the search service broker may select/designate a search broker(s) and/or individual searcher(s) to conduct the search.

Where the search broker does such designation/selection, there may be an additional fee charged for such service to the client, which may be shared in some fashion with selected/designated search broker(s) and/or individual searcher(s). In this fashion, the search service broker may, e.g., reward a previously productive search broker(s) and/or individual searcher(s) for such prior effectiveness by sharing in fees charged, e.g., to a search client for such selection/designation. This may form an incentive for existing and new searcher brokers and individual searchers to initially and continually log on to participate in searches to demonstrate. effectiveness and be rewarded for selection/designation where the search is confidential rather than open. Even if no selection/designation fee sharing occurs, searcher brokers and individual searchers will still be encouraged to participate in searchers to demonstrate competence in searching in general or searching in a particular field, country, language or the like specification of search type and thus later be selected/designated in confidential searches of similar type. Since access to participation in the search is not otherwise available without the search being open, this may be the only way for a searcher broker or individual searcher to participate in other than open searches.

Select Searches

There may be other forms of searches that are not accessible by anyone in the public with internet access, contrary to an open search. Where, e.g., the client for a search wishes to itself select or designate a searcher broker(s) or an individual searcher(s) to perform a given search, then other prospective searcher brokers and/or individual searchers may be blocked from gaining access to or knowing about a given search through the search service broker web-site.

Accessible Search Information

Certain aspects of the conduct of a search may be accessible to all searcher brokers and/or individual searchers, e.g., through the search service web-site or directly from a search web-page, once a searcher broker or individual searcher is identified as a searcher for a given search. For example the reference list may be made available to a designated searcher, individually or through a designated searcher broker so that reference identifying information may be logged in to the list. Other information, e.g., in a search web page may also be accessible, e.g., the identification of the subject matter of the search, which may include, e.g., specific language or other qualifying criteria, e.g., critical date, and also perhaps information regarding the fee schedule, including, e.g., any fee multipliers such as relevance or aging factors.

Payment Schedule

The search service web-page may also identify for the searcher brokers and the searchers a payment schedule for payment for each reference logged in to the reference web-page by a searcher or a search broker. This may be established, e.g., by a agreement between the search service broker and the individual searcher or searcher broker, e.g., as part of the individual searcher or search broker log in to the search service broker web-page. It may also be established, e.g., by contractual agreement entered into by other means either during or after the log in process.

The agreement between a searchers and a search service broker, whether direct or through a searcher broker may provide, e.g., for several different types of fee structures. By way of example, the fee structure could be a flat fee, e.g., a standard fee, for each qualifying reference entered into the reference list, e.g., on the search reference web-page. The fee schedule may also involve, for each qualified reference a designated relevance factor, e.g., a multiplication factor. A reference is one that is a high relevance reference, e.g., a Level One reference as discussed elsewhere, e.g., in the example of a patent claim prior art type of information search, an anticipatory reference (the exact same thing as the subject matter of the search is contained in the reference), then, e.g., the standard fee may be multiplied by, e.g., a factor of 1, and if the features of the remainder of the claim (the search context,) or of the subject matter are different, but the search context is in the same field, the standard fee may be multiplied by a factor of 0.75, and if the subject matter is the same, but the search context is in a different field, then the standard fee may be multiplied by a factor of 0.5. An example of the former, e.g., in the exemplary patent claim prior art search noted above, the subject matter” may be shown for the purpose of “selecting a bandwidth,” which may be considered in the art similar to but not exactly the same as “to keep the bandwidth within a selected range,” or the rest of the patent claim (the search context) may call for an “excimer laser” while the reference may be, e.g., a CO₂ laser, which may be considered in the art to be different in operation than an excimer laser. A similar example of the latter may be the Search Context is different since the reference relates to a solid state laser which may be considered in the art, e.g., to be in a different field than excimer lasers.

Other ways of “scoring” the relevance of a reference and thus its worth to the search-requesting client, and also its worth from a payment standpoint may be used in addition to or as a supplement to the just suggested example of such an arrangement, the specifics of which “scoring” are not within the scope of the present invention.

Fee Agreement

As part of the log in process the client may be required to electronically agree to certain terms and conditions regarding the solicitation by the client of the conduct of an information search or searches. This may include, e.g., a fee agreement. The fee agreement may provide for the time and manner and amounts of payment by the client for receiving the results of a solicited search, e.g., a qualified reference. The fee agreement may be a single standard agreement or the client may be given a choice of a plurality of agreements depending, e.g., on the type of search or the payment arrangements to which the client is willing to agree.

Search Payment Schedule

The fee agreement may include, e.g., a payment schedule, which may include different fees for references of different relevance and/or time of discovery as explained in more detail below. The arrangement may also include a designation of when payment is to be made by the client, e.g., for a qualified reference, e.g., immediately upon entry into the reference list by a searcher or after some determination of the fact it is a qualified reference and/or it has the appropriate relevance factor, etc. Such payment may be made in part, e.g., subject to a later multiplication factor based, e.g., on the appropriate relevance factor. This may depend upon, e.g., whether the relevance factor is assigned by the searcher broker or individual searcher, e.g., upon entry onto the Reference List, or by the Search Service Broker after such entry, or later, e.g., by some third party arbiter, e.g., in the course of a Protest Process.

Repeat Searches

In the event that a client for a search is requesting an identical or substantially identical search to a prior search for which qualifying references had been found, and where, e.g., the qualifying references also meet the criteria of the search identification for the subsequent search, the search service broker, through the ability to identify this fact from information in its database, may simply charge the client for access to the qualifying references without using any searchers. Thereby the search service broker may avoid payment to searchers again and make more than simply its commission. The client, however, may wish for the search to be conducted again, e.g., in the hope more qualifying references may arise. In this event, the search service broker in lieu of only receiving a commission as if the new search had not been done before, may charge an additional fee to conduct the search anew. The search service broker may so agree and the previously qualifying references may be agreed to be placed on the list of already known references at the start of the new search. Or else, they may be left to the searchers participating in the new search to find, with perhaps also an agreement that if not found in the new search previously found qualifying references will be disclosed to the client, again perhaps for an additional fee.

In some cases, a client may wish to have the search service broker agree not to search a particular subject matter of a search again for a different client. This may occur, e.g., in the patent claim prior art reference searching example, where a client wishes to have a prior art search conducted prior to the filing of a patent application (a patentability type search) and wish that the same search service broker not offer its services later to another client for a validity type prior art search trying to invalidate the prior client's patent should it be granted by the patent office. In such event the search service broker may also charge an additional fee to agree to such an arrangement.

Search Client Bonus

In some cases, the search client may wish to induce extra effort by participating searchers or a larger number of searchers, e.g., in an open search. In such a case the searcher client may specify a higher fee for a qualifying reference or a qualifying reference of a particular relevance factor or such which is entered onto the applicable reference web-page before some selected date/time. Such a bonus, e.g., several times what the search broker usually charges for a qualified reference or a qualified reference of a particular relevance level, may be treated as noted above for purposes of fee collection searcher payment dispute process, etc., but may provide a client with some heightened level of urgency to obtain search results and/or search results of some relevance level, may add the bonus payment(s) according to urgency level.

Payment Information

The log in and/or the contractual process (i.e., included within a fee agreement), may also provide information regarding how and when the client is to be billed for a reference being provided to the client. For example, information may be provided to the search service broker that can, e.g., enable the search service broker to electronically charge some account of the client, e.g., upon entry of a reference into the reference list or, as noted above, some later agreed-upon time. The search service broker may have the web-site set up so that, if agreed-upon, this automatically occurs upon such entry of a reference onto the reference list, again subject, e.g., to future review and or modification of the fee so charged. It is also possible that upon the transfer of such reference fee to the search service broker's account from the client account, the system may then, based upon payment information received from a searcher broker or individual searcher, credit the reference fee to the account of the searcher broker or individual searcher, less any commission agreed upon by the searcher broker or individual searchers and the search service broker to be due to the search service broker.

Also contained on the searcher broker web-page and/or the individual searcher web-pages or in a database accessible through any or all of the search service broker web-site, the searcher broker web-page and individual searcher we-page, may be information on how and where to pay the individual searcher or the searcher broker for a successful registration of an information containing document. for example the information may enable the searcher to be automatically paid, e.g., as soon as a client is charged for a qualified reference, e.g., a prior art reference, is logged on to the reference list web-page on the search reference list web-page.

Payment Arrangement

The search web-page may also identify one of many possible payment arrangements. For example, when a qualifying reference is entered into the list of the search reference web-page, then, e.g., the client may be automatically charged for the fee for the finding of the piece of information, e.g., the prior art reference. This may be done, e.g., according to a fee structure. The searcher broker or searcher may be paid that amount, less whatever commission or other fee the search service broker is to retain for brokering the arrangement between the searcher and the client seeking the services of a searcher(s).

For purposes of this example, the qualifying reference may constitute a qualifying reference if, e.g., it satisfies two criteria, i.e., it is a unique reference and it is logged into the search web-page reference list first in time. That is, the reference is unique in the sense that it is not a duplicate of an earlier logged in reference. In some cases, e.g., the exemplary patent claim prior art search, the qualified reference may also have to satisfy the criteria that it is, e.g., under the patent law, and effective reference as of before a designated critical date.

For purposes of fee and payment, e.g., the Search Broker or the individual Searcher, as appropriate, may enter a stated relevance factor, e.g., to trigger the pertinent multiplication factor to be applied to the reference finder fee. Alternatively, the search service broker, as part of the brokering service, may determine the relevance factor and use it to establish the actual reference finder fee to be charged to the client and used to base the payment to the searcher broker or the individual searcher.

In another exemplary embodiment, a flat fee of, e.g., the lowest multiplication factor may initially be charged automatically and paid automatically, less commission or the like, and the increase in fee and payment due, e.g., to a higher relevance factor charged and paid later. The later adjustment of the fee and consequent searcher payment may also be done through the search service broker web-site.

There may also be a protest process, whereby, e.g., the client seeking the search may challenge whether or not the qualified reference was indeed a qualified reference. The client may question, e.g., whether the same reference had already been entered into the search web-page reference list, e.g., due to differing ways of identifying the purported qualified reference. Also the client and/or the searcher broker or individual searcher may challenge whether the relevance factor assigned to the qualified reference was in fact correct.

In addition as part of the defining of a search either the client or search service broker or both may contribute to the definition of a qualified reference other possible criteria, e.g., a particular language or particular required database or library of other collection of information containing references. Also, the definition of a qualified reference may be modified by, e.g., defining references already known at the time of the initiation of the search. These may preferable be already listed on the reference list at the outset of making the reference list available to a search broker or an individual searcher for entry of additional references which are non-duplicative of any known reference and thus a qualified reference(s). Otherwise the search service broker may make accessible to any search broker/searcher such a list of previously known references. Similarly, during any search, e.g., the client may be conducting its own ongoing search and may have access to the reference list web-page to itself enter references from time to time, thus making a later logged in duplicate reference not a qualified reference.

The challenge or protest process may take place as part of the original fee charging and payment process or thereafter, on or through the search service broker web-site or elsewhere, as may be agreed upon by the parties and/or technically feasible over the Internet.

Another aspect of fee charged and payment received may be due to aging of the search. A qualified reference may also receive some modification factor to the fee charged to the search client, e.g., a standard fee or a standard fee time some relevance factor, and the consequent payment to the searcher broker or individual searcher, e.g., based upon the aging of the search. For example, based upon the difference between the date stamp for the initiation of the search, e.g., found on the search web-page and/or some database, and the date stamp for the entry of the qualified reference into the search web-page reference list, the size of the fee charge, and consequent amount paid may increase as time increases. This may be, e.g., in some discrete fashion as, e.g., days or weeks pass or based on some linear algorithm and raw time difference, etc.

A searcher broker or individual searcher may be induced to delay the logging in of a qualified reference on to the search web-page reference list, however, doing so runs the risk of being beaten in time by another search broker or individual searcher logging in the same reference.

According to aspects of another embodiment of the present invention certain searches may be made blind to the client, meaning, e.g., that the reference list or some portion thereof may be made inaccessible to the client. In this manner, e.g., a searcher may log in a reference into the reference list, or portion not accessible to the client, and then itself or through the search service broker, describe the content of the reference, e.g., with a short narrative. This may thus allow the client to specify an amount the client is then willing to pay for the full identification of the reference. Such a bidding process could go on, e.g., as the search remains active for another searcher(s) to potentially log in the same reference. In such event, the second log-in may be considered to be a qualified reference, since the prior log in by the other searcher may be considered, during such a bidding process, as a conditional log-in. Thus by trying to bid up the fee for the finding of the reference and consequent payment to the searcher the searcher may lose its place in the queue of the reference list and have its provisional log in eliminated by the later in time log in.

Payment Protest Process

Regardless of when it may occur in the process, e.g., prior to or after Fee charges to the client for the search and/or prior to or after payment to the searcher broker and/or individual searcher, a protest procedure may occur this may be conducted through or over the search service broker web-site or handled separately by and among the parties. The search service broker may be the arbitrator for any such payment protest, e.g., by directly participating in the determination of the fact that a qualified reference has been logged into the system and/or in determining such matters as the relevance factor. Alternatively, the search service broker may participate only to the extent of arranging for a third party to conduct the arbitration of the issues in question, perhaps even as a part of a system where such third part takes care of all payments, e.g., for a fee of a portion of the search service broker's commission. Further in the alternative, the parties may separately agree that another person or persons or entity be the arbiter of any such dispute.

A dispute may arise as to whether the reference is a Qualified Reference, i.e., subjectively whether it actually discloses the Subject Matter of the particular search or whether it is a unique reference, i.e., someone else with an earlier date stamp had actually logged in the same reference, perhaps described or identified slightly differently, but actually the same reference. A dispute may arise over, e.g., whether the appropriate Relevance Factor was assigned, etc. In accordance with the protest process the fee to be charged or to be charged the client and/or the payment made or to be made to the searcher may thus be modified.

Such a modification may occur subsequently to the fee having been charged to a client and/or subsequently to payment having been made to a searcher (individual searcher or searcher broker) as an adjustment thereto. The process may occur before a fee is charged or after. It may occur before the fee is charged and consequent payment made as determined by some payment criteria (e.g., designation as a qualified reference) and later as to others (e.g., relevance factor). Thus, e.g., software may be used to compare identification of references entered onto the reference list, and, if some level of duplication is not detected as to previously logged in references, then the system may assume that the newly entered reference is a unique reference and based on other data entered on the reference list, e.g., critical date, etc. assume that it is a qualified reference and automatically charge the finding fee to the client and automatically make the payment to the searcher. Otherwise, if the software determines in such a comparison with other references that there is a duplication, including, e.g., if the same reference has been entered with the same title in two different languages, then no fee is charged and no payment made for the later date stamped item. These and other possible automated decisions handled by software operating on or in conjunction with the search service broker web-site can, of course, be subject to later review, e.g., in a protest process. Also, rather than automated, the charging of fees and payment of searchers may be handled by the search service broker. This may include a preliminary review by the search service broker of such things as the qualifying criteria being met for a qualifying reference and the appropriateness of the assigned relevance factor, if assigned by the searcher or the assignment of a relevance factor by the search service broker.

Rating System

Utilization of information gathered during the search/expert brokering process, e.g., in the search service broker's database, may be used, according to aspects of an embodiment of the present invention to, e.g., to rate various aspects of the process and/or participants in the process. For example searchers may be rated by name or anonymously for prior successful performance of a search or searches, e.g., by technology category, e.g., the number of references produced, the time to production, e.g., an average time to production. Clients may be rated, e.g., for percentage of references provided that are caused by the client to be the subject of a protest process. These ratings may be utilized to select searchers and/or searcher brokers, by the client or search service broker, by name or anonymously, e.g., by number. They may be used by searchers to decide, e.g., whether to participate in a search for a given client, identified by name or anonymously, e.g., by number. The rating data or some of it may be made available to anyone accessing the search service broker web-site or only by specific release of the data by the search service broker. The dispute process itself may be rated, e.g., numbers of occurrences and numbers of references found to be qualified references, e.g., as a percentage of those disputed, or found to have been given the right relevance factor, and participants in the process, e.g., percentages of success in meeting a the requirements for, e.g., a qualified reference and/or a given relevance factor, etc. when challenged.

It will be understood from the above by those skilled in the art that a method of providing the service of obtaining information for a client is disclosed, which may comprise, providing a search service brokering internet location; providing an information search identification internet location accessible on or through the search service brokering internet location; providing an information search reference internet location associated with the information search identification internet location; and providing access to a searcher to the information search identification internet location to identify the subject matter of a search and access to the information search reference internet location to log in a reference. By way of example of a search may be a search relating to finding prior art references relevant to a claim in an issued patent, e.g., a U.S. Patent. The search service brokering internet location may comprise a search service broker web-site; and the search identification internet location may comprises a search service broker web-site search web-page; and, the search reference internet location may comprise a search service broker web-site reference web-page. Those skilled in the art will understand that such Internet sites, e.g., web-site(s) and web-page(s) may be linked or otherwise made accessible in a variety of ways and combinations of ways within the scope and spirit of aspects of embodiments of the present invention.

The internet locations may include a data processing system(s) that, e.g., may also be controlled by suitable software, e.g., running on one or more servers and also provided through and/or accessible through an independent service provider (“ISP”). Also, as will be understood by those skilled in the art, one or more databases may be linked to or otherwise cooperative with, e.g., the search service broker web-page, and, e.g., updatable through, providing information to and/or actually automatically controlling certain aspects of the interrelationships of, e.g., the client, search service broker and searcher brokers or individual searchers, within the scope of aspects of embodiments of the above described methods. The use of terms such as web-site or web-page are intended to be broad enough to encompass any equivalent such Internet locations and their links and accessibility and the like from one to the other in accordance with, e.g., carrying out the functionalities noted above according to aspects of embodiments of the present invention. The exact linkages and nesting of such sites and pages over the internet are not important to the scope of aspects of embodiments of the present invention, but rather the ability to carry out the noted functionalities within the technical architecture, structure, software and the like capabilities of such Internet locations and interconnections as are known to those skilled in the art.

The method may also comprise date stamping the log in of a reference. Those skilled in the art will understand various ways of assigning such date stamp (date/time) information based upon activity in either or both of the above noted Internet locations, e.g., a reference list log-in or by or through, e.g., the search service broker web-page, e.g., as a reference is logged in. The data processing system (and/or data base) may record such information as the date stamps for a given search start date/time and/or the log in date/time for a particular reference and may also place such information directly onto an appropriate web-page or enable the information to be made accessible through such an appropriate web-page, e.g., by accessing the data base there through.

The method may further comprise logging in a client requesting a search; and logging in the identification of the search requested by the client and creating the search identification internet location for the respective search. The identification of the search may comprise a specific subject matter of the search for each respective search, which may, as noted above be in a variety of forms and, e.g., based on some language in an actual patent or some short narrative description of the subject matter. In this regard searcher will be understood to mean an individual searcher and/or a person or entity providing other individual searchers, e.g., a searcher broker representing a group of searchers and, unless otherwise specifically indicated in the accompanying claims are to be considered to be the same for purposes of interpreting the accompanying claims.

The method may comprise logging in a searcher to do a search before providing the searcher with access to the search reference internet location to log in a reference. The method may comprise providing access to the information search identification internet location for the purpose of allowing a searcher to log in as a searcher for the search identified in the information search identification internet location, e.g., an open search. The method may further comprise charging a reference fee to the client for each entry of a qualified reference onto the search reference internet location wherein a qualified reference is a unique reference containing information that is the subject matter of the search and is logged into the search reference internet location earliest in time, and also comprise paying a portion of the reference fee to a searcher broker or individual searcher entering the qualified reference onto the search reference internet location. The method may further comprise determining the reference fee based upon the time since the information search was initiated.

The method may also comprise logging in a selected individual searcher to do a particular search, which may be selected by the client, e.g., using information provided by the search service broker. The selection may be made, e.g., by selection of a searcher broker which then designates such a selected searcher(s) or provide further information to the client indirectly or through the search service broker, e.g., on the search service broker web-page, from which the client can make such a designation/selection of respective individual searchers. The selection may also be made, e.g., by the search service broker for the client.

While the particular aspects of embodiment(s) of the WEB-BASED METHOD FOR SOLICITING SEARCHES FOR INFORMATION described and illustrated in this patent application in the detail required to satisfy 35 U.S.C. §112 is fully capable of attaining any above-described purposes for, problems to be solved by or any other reasons for or objects of the aspects of an embodiment(s) above described, it is to be understood by those skilled in the art that it is the presently described aspects of the described embodiment(s) of the present invention are merely exemplary, illustrative and representative of the subject matter which is broadly contemplated by the present invention. The scope of the presently described and claimed aspects of embodiments fully encompasses other embodiments which may now be or may become obvious to those skilled in the art based on the teachings of the Specification. The scope of the present WEB-BASED METHOD FOR SOLICITING SEARCHES FOR INFORMATION is solely and completely limited by only the appended claims and nothing beyond the recitations of the appended claims. Reference to an element in such claims in the singular is not intended to mean nor shall it mean in interpreting such claim element “one and only one” unless explicitly so stated, but rather “one or more”. All structural and functional equivalents to any of the elements of the above-described aspects of an embodiment(s) that are known or later come to be known to those of ordinary skill in the art are expressly incorporated herein by reference and are intended to be encompassed by the present claims. Any term used in the specification and/or in the claims and expressly given a meaning in the Specification and/or claims in the present application shall have that meaning, regardless of any dictionary or other commonly used meaning for such a term. It is not intended or necessary for a device or method discussed in the Specification as any aspect of an embodiment to address each and every problem sought to be solved by the aspects of embodiments disclosed in this application, for it to be encompassed by the present claims. No element, component, or method step in the present disclosure is intended to be dedicated to the public regardless of whether the element, component, or method step is explicitly recited in the claims. No claim element in the appended claims is to be construed under the provisions of 35 U.S.C. §112, sixth paragraph, unless the element is expressly recited using the phrase “means for” or, in the case of a method claim, the element is recited as a “step” instead of an “act”.

It will be understood by those skilled in the art that the aspects of embodiments of the present invention disclosed above are intended to be preferred embodiments only and not to limit the disclosure of the present invention(s) in any way and particularly not to a specific preferred embodiment alone. Many changes and modification can be made to the disclosed aspects of embodiments of the disclosed invention(s) that will be understood and appreciated by those skilled in the art. The appended claims are intended in scope and meaning to cover not only the disclosed aspects of embodiments of the present invention(s) but also such equivalents and other modifications and changes that would be apparent to those skilled in the art. In additions to changes and modifications to the disclosed and claimed aspects of embodiments of the present invention(s) noted above others could be implemented.

I/We claim:

1. A method of providing the service of obtaining information for a client comprising:
providing a search service brokering internet location;
providing an information search identification internet location accessible on or through the search service brokering internet location;
providing an information search reference internet location associated with the information search identification internet location; and
providing access to a searcher to the information search identification internet location to access the subject matter of the search and access to the information search reference internet location to log in a reference related to the subject matter of the search.

2. The method of claim 1 further comprising:
the search service brokering internet location comprises a search service broker web-site;
the search identification internet location comprises a search service broker web-site search web-page; and,
the search reference internet location comprises a search service broker web-site reference web-page.

3. The method of claim 1 further comprising:
date stamping the log in of a reference.

4. The method of claim 2 further comprising:
date stamping the log in of a reference.

5. The method of claim 1 further comprising:
logging in a client requesting a search;
logging in the identification of the search requested by the client and creating the search identification internet location for the respective search.

6. The method of claim 2 further comprising:
logging in a client requesting a search;
logging in the identification of the search requested by the client and creating the search identification internet location for the respective search.

7. The method of claim 3 further comprising:
logging in a client requesting a search;
logging in the identification of the search requested by the client and creating the search identification internet location for the respective search.

8. The method of claim 4 further comprising:
logging in a client requesting a search;
logging in the identification of the search requested by the client and creating the search identification internet location for the respective search.

9. The method of claim 5 further comprising:
the identification of the search comprising a specific subject matter of the search for each respective search.

10. The method of claim 6 further comprising:
the identification of the search comprising a specific subject matter of the search for each respective search.

11. The method of claim 7 further comprising:
the identification of the search comprising a specific subject matter of the search for each respective search.

12. The method of claim 8 further comprising:
the identification of the search comprising a specific subject matter of the search for each respective search.

13. The method of claim 5 further comprising:
logging in a searcher to do a search before providing the searcher with access to the search reference internet location to log in a reference.

14. The method of claim 6 further comprising:
logging in a searcher to do a search before providing the searcher with access to the search reference internet location to log in a reference.

15. The method of claim 7 further comprising:
logging in a searcher to do a search before providing the searcher with access to the search reference internet location to log in a reference.

16. The method of claim 8 further comprising:
logging in a searcher to do a search before providing the searcher with access to the search reference internet location to log in a reference.

17. The method of claim 9 further comprising:
logging in a searcher to do a search before providing the searcher with access to the search reference internet location to log in a reference.

18. The method of claim 10 further comprising:
logging in a searcher to do a search before providing the searcher with access to the search reference internet location to log in a reference.

19. The method of claim 11 further comprising:
logging in a searcher to do a search before providing the searcher with access to the search reference internet location to log in a reference.

20. The method of claim 12 further comprising:
logging in a searcher to do a search before providing the searcher with access to the search reference internet location to log in a reference.

21. The method of claim 5 further comprising:
providing access to the information search identification internet location for the purpose of allowing a searcher to log in as a searcher for the search identified in the information search identification internet location.

22. The method of claim 6 further comprising:
providing access to the information search identification internet location for the purpose of allowing a searcher to log in as a searcher for the search identified in the information search identification internet location.

23. The method of claim 7 further comprising:
providing access to the information search identification internet location for the purpose of allowing a searcher to log in as a searcher for the search identified in the information search identification internet location.

24. The method of claim 8 further comprising:
providing access to the information search identification internet location for the purpose of allowing a searcher to log in as a searcher for the search identified in the information search identification internet location.

25. The method of claim 9 further comprising:
providing access to the information search identification internet location for the purpose of allowing a searcher to log in as a searcher for the search identified in the information search identification internet location.

26. The method of claim 10 further comprising:
providing access to the information search identification internet location for the purpose of allowing a searcher to log in as a searcher for the search identified in the information search identification internet location.

27. The method of claim 11 further comprising:
providing access to the information search identification internet location for the purpose of allowing a searcher to log in as a searcher for the search identified in the information search identification internet location.

28. The method of claim 12 further comprising:
providing access to the information search identification internet location for the purpose of allowing a searcher to log in as a searcher for the search identified in the information search identification internet location.

29. The method of claim 13 further comprising:
charging a reference fee to the client for each entry of a qualified reference onto the search reference internet location wherein a qualified reference is a unique reference containing information that is the subject matter of the search and is logged into the search reference internet location earliest in time.

30. The method of claim 14 further comprising:
charging a reference fee to the client for each entry of a qualified reference onto the search reference internet location wherein a qualified reference is a unique reference containing information that is the subject matter of the search and is logged into the search reference internet location earliest in time.

31. The method of claim 15 further comprising:
charging a reference fee to the client for each entry of a qualified reference onto the search reference internet location wherein a qualified reference is a unique reference containing information that is the subject matter of the search and is logged into the search reference internet location earliest in time.

32. The method of claim 16 further comprising:
charging a reference fee to the client for each entry of a qualified reference onto the search reference internet location wherein a qualified reference is a unique reference containing information that is the subject matter of the search and is logged into the search reference internet location earliest in time.

33. The method of claim 17 further comprising:
charging a reference fee to the client for each entry of a qualified reference onto the search reference internet location wherein a qualified reference is a unique reference containing information that is the subject matter of the search and is logged into the search reference internet location earliest in time.

34. The method of claim 18 further comprising:
charging a reference fee to the client for each entry of a qualified reference onto the search reference internet location wherein a qualified reference is a unique reference containing information that is the subject matter of the search and is logged into the search reference internet location earliest in time.

35. The method of claim 19 further comprising:
charging a reference fee to the client for each entry of a qualified reference onto the search reference internet location wherein a qualified reference is a unique reference containing information that is the subject matter of the search and is logged into the search reference internet location earliest in time.

36. The method of claim 20 further comprising:
charging a reference fee to the client for each entry of a qualified reference onto the search reference internet location wherein a qualified reference is a unique reference containing information that is the subject matter of the search and is logged into the search reference internet location earliest in time.

37. The method of claim 21 further comprising:
charging a reference fee to the client for each entry of a qualified reference onto the search reference internet location wherein a qualified reference is a unique reference containing information that is the subject matter of the search and is logged into the search reference internet location earliest in time.

38. The method of claim 22 further comprising:
charging a reference fee to the client for each entry of a qualified reference onto the search reference internet location wherein a qualified reference is a unique reference containing information that is the subject matter of the search and is logged into the search reference internet location earliest in time.

39. The method of claim 23 further comprising:
charging a reference fee to the client for each entry of a qualified reference onto the search reference internet location wherein a qualified reference is a unique reference containing information that is the subject matter of the search and is logged into the search reference internet location earliest in time.

40. The method of claim 24 further comprising:
charging a reference fee to the client for each entry of a qualified reference onto the search reference internet location wherein a qualified reference is a unique reference containing information that is the subject matter of the search and is logged into the search reference internet location earliest in time.

41. The method of claim 25 further comprising:
charging a reference fee to the client for each entry of a qualified reference onto the search reference internet location wherein a qualified reference is a unique reference containing information that is the subject matter of the search and is logged into the search reference internet location earliest in time.

42. The method of claim 26 further comprising:
charging a reference fee to the client for each entry of a qualified reference onto the search reference internet location wherein a qualified reference is a unique reference containing information that is the subject matter of the search and is logged into the search reference internet location earliest in time.

43. The method of claim 27 further comprising:
charging a reference fee to the client for each entry of a qualified reference onto the search reference internet location wherein a qualified reference is a unique reference containing information that is the subject matter of the search and is logged into the search reference internet location earliest in time.

44. The method of claim 28 further comprising:
charging a reference fee to the client for each entry of a qualified reference onto the search reference internet location wherein a qualified reference is a unique reference containing information that is the subject matter of the search and is logged into the search reference internet location earliest in time.

45. The method of claim 29 further comprising:
paying a portion of the reference fee to a searcher broker or individual searcher entering the qualified reference onto the search reference internet location.

46. The method of claim 30 further comprising:
paying a portion of the reference fee to a searcher broker or individual searcher entering the qualified reference onto the search reference internet location.

47. The method of claim 31 further comprising:
paying a portion of the reference fee to a searcher broker or individual searcher entering the qualified reference onto the search reference internet location.

48. The method of claim 32 further comprising:
paying a portion of the reference fee to a searcher broker or individual searcher entering the qualified reference onto the search reference internet location.

49. The method of claim 33 further comprising:
paying a portion of the reference fee to a searcher broker or individual searcher entering the qualified reference onto the search reference internet location.

50. The method of claim 34 further comprising:
paying a portion of the reference fee to a searcher broker or individual searcher entering the qualified reference onto the search reference internet location.

51. The method of claim 35 further comprising:
paying a portion of the reference fee to a searcher broker or individual searcher entering the qualified reference onto the search reference internet location.

52. The method of claim 36 further comprising:
paying a portion of the reference fee to a searcher broker or individual searcher entering the qualified reference onto the search reference internet location.

53. The method of claim 37 further comprising:
paying a portion of the reference fee to a searcher broker or individual searcher entering the qualified reference onto the search reference internet location.

54. The method of claim 38 further comprising:
paying a portion of the reference fee to a searcher broker or individual searcher entering the qualified reference onto the search reference internet location.

55. The method of claim 39 further comprising:
paying a portion of the reference fee to a searcher broker or individual searcher entering the qualified reference onto the search reference internet location.

56. The method of claim 40 further comprising:
paying a portion of the reference fee to a searcher broker or individual searcher entering the qualified reference onto the search reference internet location.

57. The method of claim 41 further comprising:
paying a portion of the reference fee to a searcher broker or individual searcher entering the qualified reference onto the search reference internet location.

58. The method of claim 42 further comprising:
paying a portion of the reference fee to a searcher broker or individual searcher entering the qualified reference onto the search reference internet location.

59. The method of claim 43 further comprising:
paying a portion of the reference fee to a searcher broker or individual searcher entering the qualified reference onto the search reference internet location.

60. The method of claim 30 further comprising:
paying a portion of the reference fee to a searcher broker or individual searcher entering the qualified reference onto the search reference internet location.

61. The method of claim 45 further comprising:
determining the reference fee based upon the time since the information search was initiated.

62. The method of claim 46 further comprising:
determining the reference fee based upon the time since the information search was initiated.

63. The method of claim 47 further comprising:
determining the reference fee based upon the time since the information search was initiated.

64. The method of claim 48 further comprising:
determining the reference fee based upon the time since the information search was initiated.

65. The method of claim 49 further comprising:
determining the reference fee based upon the time since the information search was initiated.

66. The method of claim 50 further comprising:
determining the reference fee based upon the time since the information search was initiated.

67. The method of claim 51 further comprising:
determining the reference fee based upon the time since the information search was initiated.

68. The method of claim 52 further comprising:
determining the reference fee based upon the time since the information search was initiated.

69. The method of claim 53 further comprising:
determining the reference fee based upon the time since the information search was initiated.

70. The method of claim 54 further comprising:
determining the reference fee based upon the time since the information search was initiated.

71. The method of claim 55 further comprising:
determining the reference fee based upon the time since the information search was initiated.

72. The method of claim 56 further comprising:
determining the reference fee based upon the time since the information search was initiated.

73. The method of claim 57 further comprising:
determining the reference fee based upon the time since the information search was initiated.

74. The method of claim 58 further comprising:
determining the reference fee based upon the time since the information search was initiated.

75. The method of claim 59 further comprising:
determining the reference fee based upon the time since the information search was initiated.

76. The method of claim 60 further comprising:
determining the reference fee based upon the time since the information search was initiated.

77. The method of claim 13 further comprising:
logging in a selected searcher to do a search before providing the searcher with access to the search reference internet location to log in a reference.

78. The method of claim 14 further comprising:
logging in a selected searcher to do a search before providing the searcher with access to the search reference internet location to log in a reference.

79. The method of claim 15 further comprising:
logging in a selected searcher to do a search before providing the searcher with access to the search reference internet location to log in a reference.

80. The method of claim 16 further comprising:
logging in a selected searcher to do a search before providing the searcher with access to the search reference internet location to log in a reference.

81. The method of claim 17 further comprising:
logging in a selected searcher to do a search before providing the searcher with access to the search reference internet location to log in a reference.

82. The method of claim 18 further comprising:
logging in a selected searcher to do a search before providing the searcher with access to the search reference internet location to log in a reference.

83. The method of claim 19 further comprising:
logging in a selected searcher to do a search before providing the searcher with access to the search reference internet location to log in a reference.

84. The method of claim 20 further comprising:
logging in a selected searcher to do a search before providing the searcher with access to the search reference internet location to log in a reference.

85. The method of claim 77 further comprising:
providing a client with information regarding an individual searcher to enable the client to select a selected individual searcher.

86. The method of claim 78 further comprising:
providing a client with information regarding an individual searcher to enable the client to select a selected individual searcher.

87. The method of claim 79 further comprising:
providing a client with information regarding an individual searcher to enable the client to select a selected individual searcher.

88. The method of claim 80 further comprising:
providing a client with information regarding an individual searcher to enable the client to select a selected individual searcher.

89. The method of claim 81 further comprising:
providing a client with information regarding an individual searcher to enable the client to select a selected individual searcher.

90. The method of claim 82 further comprising:
providing a client with information regarding an individual searcher to enable the client to select a selected individual searcher.

91. The method of claim 83 further comprising:
providing a client with information regarding an individual searcher to enable the client to select a selected individual searcher.

92. The method of claim 84 further comprising:
providing a client with information regarding an individual searcher to enable the client to select a selected individual searcher.

93. An apparatus for providing the service of obtaining information for a client comprising:
a search service brokering internet location accessible over the internet;
an information search identification internet location accessible on or through the search service brokering internet location;
an information search reference internet location associated with the information search identification internet location; and
the identification internet location providing access to a searcher on or through the search service brokering internet location to access the subject matter of the search and access to the information search reference internet location to log in a reference related to the subject matter of the search.
